(19) United States
(12) Patent Application Publication
(10) Pub. No.: US 2009/0254248 A1
(43) Pub. Date: Oct. 8, 2009

(54) SYSTEM AND METHOD FOR MANAGING RECORD OF VEHICLES

(75) Inventors: Jong-Won Park, Anyang (KR); Hyung-In Koh, Seoul (KR)

Correspondence Address: EDWARDS ANGELL PALMER & DODGE LLP, P.O. BOX 55874, BOSTON, MA, 02205, US

(73) Assignee: HK E-CAR CO., LTD., Seoul (KR)

(21) Appl. No.: 12/489,086

(22) Filed: Jun. 22, 2009

Related U.S. Application Data
(63) Continuation of application No. PCT/KR2007/000854, filed on Feb. 16, 2007.

(30) Foreign Application Priority Data
Dec. 21, 2006 (KR) 10-2006-0131701

(51) Int. Cl. G06F 19/00; G01S 5/00

(52) U.S. Cl. 701/36; 342/357.07

(57) ABSTRACT

A system for managing records of vehicles comprises an equipment unit for creating and transmitting parking/stopping data of the vehicle; and a main system for receiving the parking/stopping data of the vehicle from the equipment unit and classifying, accumulating, and managing the received parking/stopping data.

### CROSS-REFERENCE TO RELATED APPLICATION

This is a continuation application, under 35 U.S.C. § 120, of PCT/KR2007/000854 filed on Feb. 16, 2007 designating the U.S., which claims the benefit, under 35 U.S.C. § 119(a), of Korean Application No. 10-2006-0131701 filed on Dec. 21, 2006, the entire contents of which are incorporated herein by reference.

### TECHNICAL FIELD

The present invention relates to a system for managing parking/stopping records of vehicles to capture location information of the vehicles based on signals received from satellites. More specifically, the invention relates to a system for managing records of vehicles suspected to have caused an accident, in which parking/stopping of the vehicles is captured using signals received from the satellites, vehicle information and the like, and records on parking/stopping of the vehicles are managed.

### BACKGROUND ART

With the increase in population and vehicles, minor vehicle collisions occur frequently on the road. If an accident is timely handled, precious human lives may be saved. However, if the accident is not timely handled, for example, in the case of a hit-and-run accident, loss of lives and properties may be enormous.

In the case of a hit-and-run accident, if there is a witness or the accident is captured by a surveillance camera, the vehicle that has caused the accident can be traced to arrest a suspect. However, if not, possibility of arresting the suspect may not be high.

Various techniques are proposed for mitigating a hit-and-run accident. For example, there is a technique that makes a vehicle leave recognizable materials on the scene by breaking the license plate or the bumper of the vehicle or stops the engine of the vehicle if an accident occurs.

Among the techniques, Korea Patent Registration No. 10-2001-0059845 teaches a technique to employ an information terminal for tracing locations of a vehicle using a GPS (Global Positioning System).

The technique includes a GPS receiver for calculating location information of a vehicle using GPS satellite signals, a CDMA modem for transmitting identification information and a vehicle stolen report of the vehicle, and a microcomputer for controlling the GPS receiver and the CDMA modem.

However, the technique requires a lot of time and cost since vehicles would be checked one by one to determine a hit-and-run vehicle. That is, all vehicles that have passed through the scene would be investigated to determine the hit-and-run vehicle.

Furthermore, high installation costs are required since the technique needs to install a GPS receiver for processing information received through a GPS antenna, a modem for transmitting the processed information to an information center through a CDMA network, and a microcomputer for controlling the GPS receiver and the modem.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present invention has been made in order to solve the above problems, and it is an object of the invention to easily and promptly classify hit-and-run suspected vehicles to save cost and man power.

Another object of the present invention is to provide a system and method for managing parking/stopping records of vehicles to determine a hit-and-run vehicle.

In order to accomplish the above object, the present invention makes use of the fact that a hit-and-run vehicle temporarily parks/stops when an accident occurs.

Here, parking refers to a state in which a vehicle remains stopped for a reason, such as waiting for passengers, loading luggage, or being out of order, or the vehicle cannot move due the driver being out of the vehicle. Stopping refers to a state in which a vehicle stops for less than five minutes, which is a stopped state other than the parking.

When an accident occurs, the parking/stopping state occurs temporarily. Therefore, vehicles that have parked/stopped at the specific location and time of the accident can be classified as hit-and-run suspected vehicles.

In the present invention, following effects can be expected from the system and method configured as described above.

First, a vehicle that has caused an accident can be easily inquired. That is, in the present invention, among the information on vehicles that have passed the scene when an accident occurred, only information on vehicles that parked/stopped at the scene is stored. Accordingly, vehicles suspected to have caused an accident are easily inquired.

Second, hit-and-run suspected vehicles are easily classified, and thus cost and manpower are saved. Since all vehicles that have passed the area at the time when an accident occurred are checked, a lot of cost and manpower are required in a conventional method of searching for a hit-and-run vehicle using GPS. However, in the present invention, since parking/stopping of a hit-and-run vehicle is recorded, the number of vehicles to be checked is drastically reduced when an accident is investigated.

Therefore, the present invention is effective in that a hit-and-run vehicle can be sufficiently traced with a few cost and manpower by inquiring parking/stopping records of vehicles.

### BRIEF DESCRIPTION OF THE DRAWINGS

FIG. 1 is a conceptual view showing the configuration of a system according to an embodiment of the present invention.

FIG. 2 is a specific view showing the configuration of a system according to an embodiment of the present invention.

FIG. 3 is a conceptual view showing the configuration of a system using data transmission between vehicles.

FIG. 4 is a conceptual view showing the configuration of a system using a collection post.

FIG. 5 is a flowchart illustrating a method of an embodiment of the present invention.

FIG. 6 is a flowchart illustrating the step of transmitting data between vehicles.

FIG. 7 is a flowchart illustrating the data transmission step.

FIG. 8 is a flowchart illustrating the determination and data creation step.

FIG. 9 is a flowchart illustrating another method of an embodiment of the present invention.

### DESCRIPTION OF EXEMPLARY EMBODIMENTS

Hereinafter, exemplary embodiments of the present invention will be described in detail with reference to the accompanying drawings.

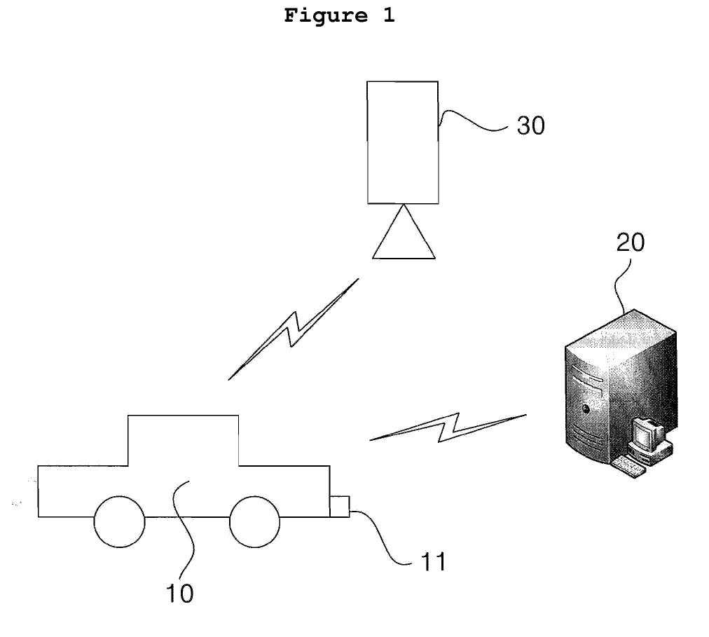

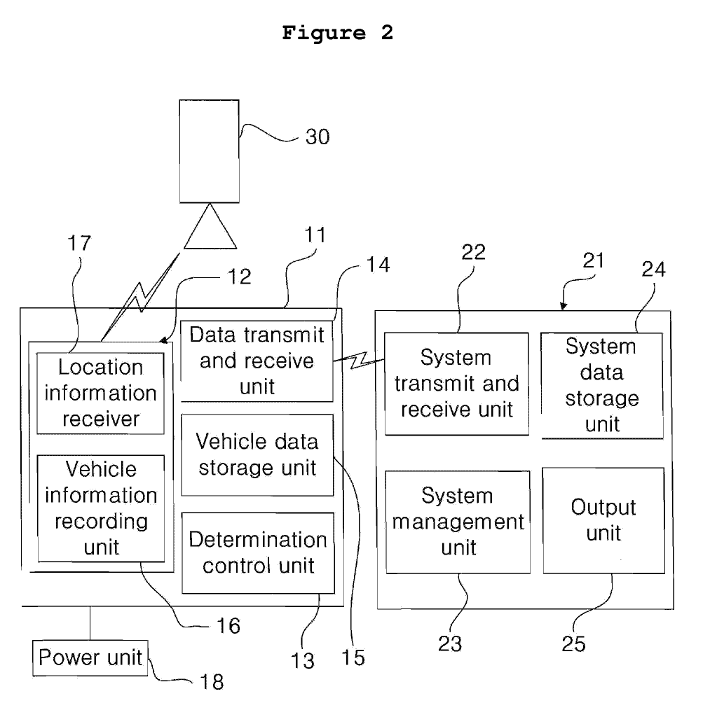

FIG. 1 is a conceptual view showing the configuration of a system according to an embodiment of the present invention. FIG. 2 is a specific view showing the configuration of a system according to an embodiment of the present invention. As shown in FIG. 1, the system of the embodiment comprises an equipment unit and a main system.

As shown in FIG. 2, the equipment unit 11 includes an information collection unit 12 for collecting vehicle information including location information of a vehicle, a determination control unit 13 for determining whether the vehicle is parked/stopped based on the collected vehicle information and creating parking/stopping data, and a data transmit and receive unit 14 for transmitting the parking/stopping data created by the determination control unit.

The equipment unit 11 is attached to a vehicle 10 and creates parking/stopping data of the vehicle using satellite signals and vehicle information.

Since the equipment unit 11 is an apparatus that informs occurrence of an accident, it is preferable that a user is not allowed to remove the equipment unit at his/her own will. Accordingly, the equipment unit is preferably formed together with the license plate of the vehicle as a single body.

However, the equipment unit 11 is not necessarily mounted on the license plate of a vehicle. The equipment unit 11 should be attached to the vehicle while traveling, and it should to be mounted on the vehicle such that the driver may not intentionally or arbitrarily remove or destroy the equipment unit 11. Accordingly, the scope of the invention is not limited to attaching the equipment unit 11 to the license plate of a vehicle.

The equipment unit 11 may be mounted on the license plate of a vehicle in a variety of ways. For example, the equipment unit 11 may be formed on the rim of the license plate or at a fixing screw of the license plate as a single body.

The vehicle information includes location information, speed information, brake signals, and registration information of a vehicle. Specifically, the location information of a vehicle is geographical information of the vehicle based on signals transmitted from satellites such as GPS, or the location information is GPS information.

The speed information of a vehicle may be data obtained by measuring speed or acceleration of the vehicle by a sensor attached to the vehicle. The speed information may be data received or calculated based on the GPS information.

The brake signals which provide information on driver's stepping on the brake of a vehicle are detected by a sensor attached to the vehicle. Generally, since drivers frequently step on the brake pedal when a vehicle accident occurs, the brake signals may be important information.

The registration information of a vehicle is registered information of the vehicle such as a vehicle number, vehicle type, manufactured year, and the like. A vehicle may be identified by the registration information of the vehicle.

The information collection unit 12 is a component of the equipment unit 11 for collecting and providing information so that the equipment unit 11 may determine whether the vehicle is parked or stopped. The information collected by the information collection unit 12 includes the location information and vehicle information of the vehicle described above.

As shown in FIG. 2, the information collection unit 12 further preferably includes a location information receiver 17 for receiving signals related to location information of a vehicle from the satellite, and a vehicle information recording unit 16 in which the vehicle information is inputted.

The location information receiver 17 receives location information of the vehicle from the satellite 30. Generally, the location information receiver 17 is a GPS receiver. The location information receiver 17 may receive signals containing information such as longitude, latitude, time, speed, altitude and the like of the vehicle from the GPS satellite. The location information receiver may be a general-purpose receiver that is provided to the public and sold in the market.

The vehicle information recording unit 16 receives signals generated by the sensor attached to the vehicle as described above or registration information of the vehicle. In addition, the vehicle information recording unit may store the information described above.

The determination control unit 13 is a component of the equipment unit 11 for analyzing the information collected by the information collection unit 12, determining whether the vehicle is parked/stopped, and creating parking/stopping data of the vehicle.

The parking/stopping data of the vehicle is log data recoding locations and times of parking/stopping the vehicle. When the log data is transmitted to the main system 20, it includes the previously stored GPS satellite information and vehicle information.

The data transmit and receive unit 14, which is a component for transmitting and receiving data, may be a general-purpose transmit and receive apparatus.

On the other hand, the equipment unit 11 further preferably includes a vehicle data storage unit 15 for storing the parking/stopping data created by the determination control unit 13. If the created parking/stopping data is simply transmitted and deleted, the data may be lost when the transmission is failed, and thus a gap is created in the parking/stopping data. Therefore, it is preferable to store the parking/stopping data until the data is completely transmitted and received by the main system or another vehicle.

The vehicle data storage unit 15 may be a general-purpose data storage apparatus and a recording medium sold in the market may be used. For example, the vehicle data storage unit 15 may be flash memory, an SD card, a CF card, or the like.

It is most preferable to include a power unit 18 for generating power by a solar battery cell for the equipment unit 11 so that power of the vehicle may be independently supplied by power of the solar battery cell. Supplying independent power is advantageous since it is not easy to supply power externally and it may prevent a user from cutting off power at will so that the parking/stopping data of the vehicle may not be created. The solar battery cell may be a general-purpose solar battery cell sold in the market.

As shown in FIG. 2, the main system 20 includes a system transmit and receive unit 22 for receiving and transmitting the parking/stopping data of a vehicle transmitted by the equipment unit 11, and a system management unit 23 for managing the parking/stopping data of the vehicle and outputting the parking/stopping data in a recognizable form.

The main system 20 receives the parking/stopping data of the vehicle transmitted from the equipment unit 11 and manages the received parking/stopping data. It may be a networked computer server and is the most important component in the system of the present invention that collects and manages all kinds of information.

Since the object of the system of the present invention is to trace a hit-and-run vehicle, it is preferable to operate the system by a public organization or an institution trusted by the public organization.

The system transmit and receive unit 22 receives the parking/stopping data created by the equipment unit of the vehicle or transmits data to the equipment unit 11 of the vehicle. Since the functions of the system transmit and receive unit 22 are almost similar to those of the data transmit and receive unit 14, it is desirable to refer to the functions of the data transmit and receive unit 14 of the equipment unit 11 described above for detailed descriptions.

The data transmit and receive unit 14 of the equipment unit 11 is configured to transmit and receive data to and from the system transmit and receive unit 22 of the main system 20 through a wire/wireless communication network. For example, a previously constructed communication infrastructure may be used, or an LBS (Location Based Service) network, CDMA network, wireless LAN, pager network or the like may be used.

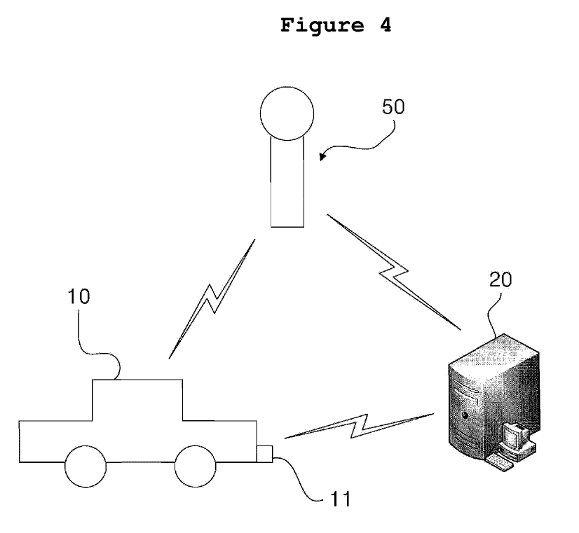

In addition, the data transmit and receive unit 14 of the equipment unit 11 may be configured to transmit and receive data to and from the system transmit and receive unit 22 of the main system through a collection post 50 provided on the road. FIG. 4 is a conceptual view showing the configuration of a system using a collection post 50.

As shown in FIG. 4, since signals transmitted from the equipment unit 11 may not be received by the main system 20 and the main system cannot directly receive signals when the signals are weak, the collection post 50 for collecting signals is installed on the roadside.

The collection post 50 is preferably configured to receive signals and transmit the signals to the main system. The collection post is configured to transmit the signals to the main system through a wire/wireless communication network.

The system management unit 23 is a component for controlling and managing the components or data of the main system 20. In addition, the system management unit 23 may inquire parking/stopping data of a vehicle. In this case, the system management unit 23 may inquire parking/stopping data of a vehicle that was at a specific area at a specific time using a log inquiry program. Using the log inquiry program, the system management unit 23 may confirm the parking/stopping data as a list or locations on a map and output the parking/stopping data in the form of a report.

In the configuration described above, the main system 20 further preferably includes a system data storage unit 24 for storing data received through the system transmit and receive unit 22.

In addition, in the configuration described above, the main system 20 further preferably includes an output unit 25, and the output unit is preferably configured to output data transmitted from the system management unit 23 in a recognizable form.

The parking/stopping data as well as past data of a vehicle may be inquired at any time from the system data storage unit 24, and thus utility of the system of the present invention is enhanced. A general-purpose storage medium may be used as the system data storage unit 25.

The output unit 25 includes a variety of output apparatuses, such as a monitor for visually displaying data, a printer, and the like.

Each of the constitutional components of the embodiment operates or acts as described below.

First, the information collection unit 12 of the equipment unit 11 of a vehicle collects information. The location information receiver 17 receives signals from satellites to create location information, or the vehicle information recording unit 16 collects information on the vehicle.

The collected location information of the vehicle and the like are transferred to the determination control unit 13, and the determination control unit 13 determines whether the vehicle is parked/stopped based on the collected information. If the vehicle is in a parking/stopping state, parking/stopping data of the vehicle is created.

As shown in FIG. 1, the created parking/stopping data is stored in the vehicle data storage unit 15 and transmitted to the main system through the data transmit and receive unit 14. At this point, the parking/stopping data may be transmitted directly to the main system. Alternatively, the parking/stopping data may be transmitted to the main system 20 by way of the collection post 50 as shown in FIG. 4.

The main system 20 receives the parking/stopping data through the system transmit and receive unit 22, and the system management unit stores the parking/stopping data in the system data storage unit 24.

In addition, when the parking/stopping data is inquired, the system management unit 23 may inquire the parking/stopping data through the log inquiry program, and the output unit 25 outputs the parking/stopping data in a recognizable form.

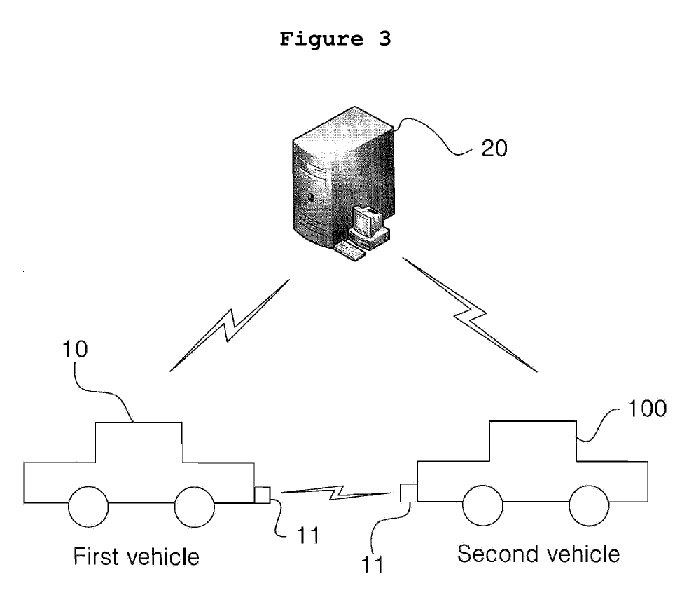

FIG. 3 is a conceptual view showing the configuration of a system using data transmission between vehicles. As a second embodiment of the present invention, the system is configured to transmit and receive data between vehicles as shown in FIG. 3.

The system of the second embodiment comprises a first equipment unit 11 mounted on a first vehicle 10, for creating and transmitting parking/stopping data of the vehicle, a second equipment unit 11 mounted on at least one second vehicle 100 other than the first vehicle, for creating and transmitting parking/stopping data of the vehicle, and a main system 20 for receiving the parking/stopping data from the equipment units 11 of the first and second vehicles and classifying, accumulating, and managing the received parking/stopping data.

The first and second vehicles are vehicles different from each other, and the second vehicle 100 represents at least one vehicle other than the first vehicle. Accordingly, the second vehicle 100 may be a plurality of vehicles.

The equipment unit 11 and the main system 20 are the same as described above. However, the equipment units of the first and second vehicles have the exactly same configuration and transmit and receive data to and from the main system 20.

Each of the constitutional components of the embodiment operates or acts as described below.

The parking/stopping data of a vehicle created as described above is stored in a vehicle data storage unit 15. At this point, a collection post 50 may not exist, or the vehicle may travel an area from which the main system 20 is not connectible.

As shown in FIG. 3, the parking/stopping data stored in the first vehicle 10 is transmitted to the data transmit and receive unit of the second vehicle 100 through the data transmit and receive unit of the first vehicle when the second vehicle 100 approaches within an electrically connectible distance.

The transmitted parking/stopping data of the first vehicle 10 is stored in the vehicle data storage unit 15 of the second vehicle 100 and transmitted to the main system 20 through the data transmit and receive unit of the second vehicle when the second vehicle 100 approaches to a location from which the main system 20 is connectible.

In this manner, by transmitting data between vehicles, the parking/stopping data may be transmitted to a vehicle that has further recently transmitted the parking/stopping data to the main system 20, and thus efficiency of collecting the parking/stopping data may be maximized.

A method of managing parking/stopping records of a vehicle performed in the embodiments of the present invention is described below.

The method of managing parking/stopping records of a vehicle performed by the system of the present invention includes an information collection step S100 for receiving vehicle information including location information of the vehicle collected by the information collection unit, a determination and data creation step S200 for analyzing the received vehicle information, determining whether the vehicle is parked/stopped, and creating the parking/stopping data, by the determination control unit, a data transmission step S300 for transmitting the created parking/stopping data to the main system through the data transmit and receive unit, a data receiving step S400 for receiving the created and transmitted parking/stopping data through the system transmit and receive unit, by the system management unit, and a system data storing step S500 for storing the received parking/stopping data into the system data storage unit.

In addition, a method of indirectly transmitting and receiving parking/stopping data of a vehicle to the management system by transmitting and receiving the parking/stopping data to and from another vehicle in the previously described second embodiment includes an information collection step S100 for receiving vehicle information including location information of the vehicle collected by the information collection unit, a determination and data creation step S200 for analyzing the received vehicle information, determining whether the vehicle is parked/stopped, and creating parking/stopping data, by the determination control unit, and an inter-vehicle data transmission step S260 for transmitting the created parking/stopping data to the equipment unit of another vehicle through the data transmit and receive unit.

On the other hand, as another method of performing the embodiment described above, the method may be configured to allow the main system to receive signals through a command, as well as passively receiving signals transmitted by a vehicle. The method includes a command transmission step S900 for transmitting a command to the equipment unit of a vehicle through the system transmit and receive unit to direct the equipment unit to transmit parking/stopping data of the vehicle, a data receiving step S910 for receiving the parking/stopping data of the vehicle created and transmitted by the equipment unit attached to the vehicle that has received the command, by the system management unit through the system transmit and receive unit, and a data storing step S920 for storing the received parking/stopping data in the system data storage unit.

Hereinafter, a method of the present invention is described in detail through an embodiment of the present invention referring to the accompanying drawings.

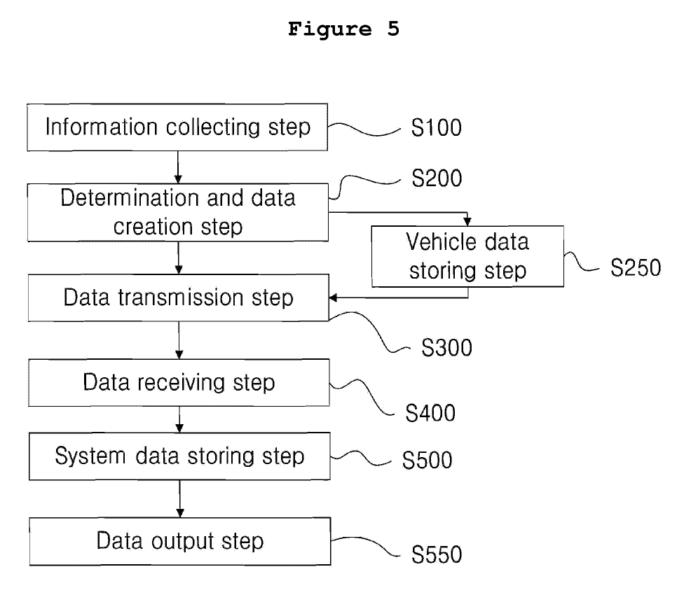

FIG. 5 is a flowchart illustrating a method of an embodiment of the present invention.

In the information collection step S100, the determination control unit receives vehicle information including location information of a vehicle collected by the information collection unit. The information collection unit and the vehicle information are the same as described above.

In the determination and data creation step S200, the determination control unit analyzes the vehicle information received from the information collection unit, determines whether the vehicle is parked/stopped, and creates parking/stopping data.

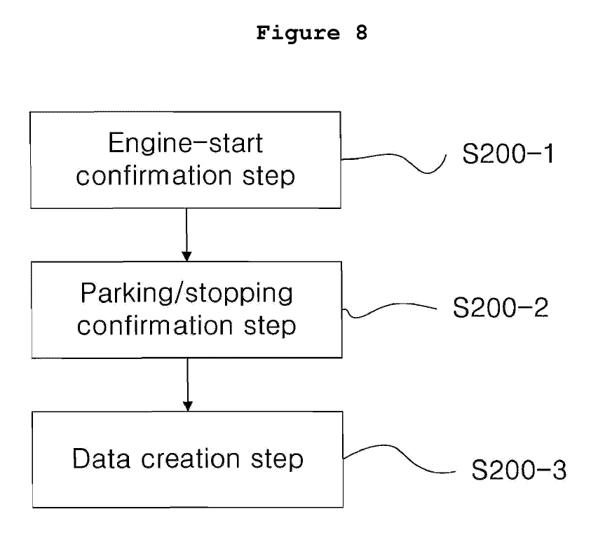

FIG. 8 is a flowchart illustrating the determination and data creation step. As shown in FIG. 8, the determination and data creation step further includes an engine-start confirmation step S200-1 for receiving vehicle information from the vehicle information recording unit and confirming whether the engine of the vehicle is started, by the determination control unit, a parking/stopping confirmation step S200-2 for confirming whether the vehicle is in a parking/stopping state if the engine of the vehicle is started, and a data creation step S200-3 for creating parking/stopping data of the vehicle including the location and vehicle information of the vehicle if the vehicle is in a parking/stopping state.

In the engine-start confirmation step S200-1, the determination control unit receives the vehicle information from the vehicle information recording unit and confirms whether the engine of the vehicle is started. For example, whether the engine of the vehicle is started may be confirmed by a sensor attached to the vehicle. If the engine of the vehicle is not started, the vehicle is not in a state to cause an accident, and thus parking/stopping data does not need to be created any more.

The parking/stopping confirmation step S200-2 is a step performed after start of the engine is confirmed, in which whether the vehicle is in a parking/stopping state is confirmed. Whether the vehicle is in a parking/stopping state may be confirmed by acquiring speed, RPM, change of location and the like of the vehicle. If the vehicle is not in a parking/stopping state, parking/stopping data does not need to be created any more.

In the data creation step S200-3, parking/stopping data of the vehicle including the location and vehicle information of the vehicle is created if the vehicle is in a parking/stopping state. However, if the parking/stopping state is not changed, the initially created parking/stopping data is recorded only once. The parking/stopping data is same as described above.

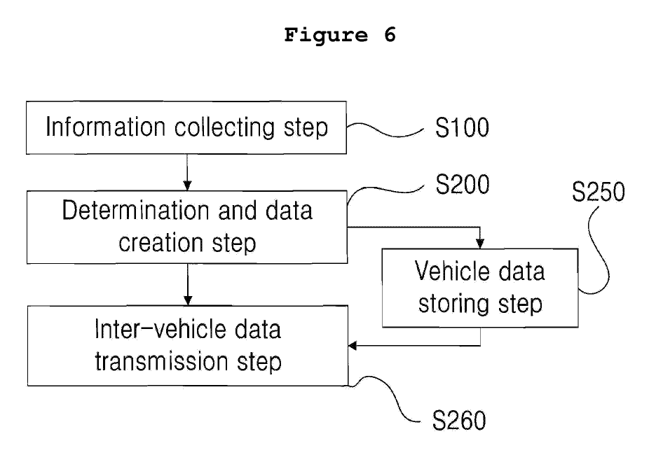

FIG. 6 is a flowchart illustrating the step of transmitting data between vehicles. As shown in FIG. 6, the step of transmitting data between vehicles includes an information collection step S100 for receiving vehicle information including location information of the vehicle collected by the information collection unit, by the determination control unit, a determination and data creation step S200 for analyzing the received vehicle information, determining whether the vehicle is parked/stopped, and creating parking/stopping data, and an inter-vehicle data transmission step S260 for transmitting the created parking/stopping data to the equipment unit of another vehicle through the data transmit and receive unit.

The information collection step and the determination and data creation step are the same as described above.

In the inter-vehicle data transmission step S260, the equipment unit of the first vehicle transmits parking/stopping data of the first vehicle to the equipment unit of the second vehicle. After transmitting the parking/stopping data of the first vehicle, the parking/stopping data of the first vehicle is transmitted to the main system in the steps described above.

As shown in FIG. 5, the present invention further preferably includes a vehicle data storing step S250 for storing the parking/stopping data of a vehicle in the vehicle data storage unit.

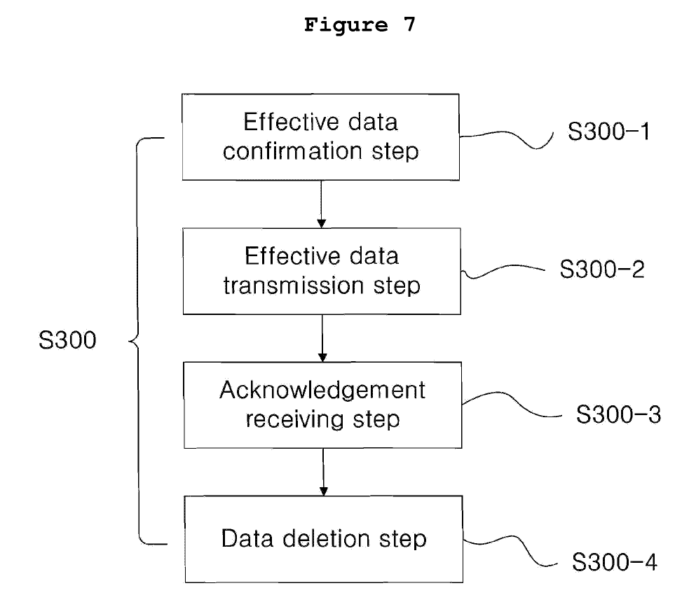

FIG. 7 is a flowchart illustrating the data transmission step S300. A method of further efficiently operating the system when the vehicle data storing step S250 is included is described below with reference to FIG. 7.

That is, the data transmission step S300 includes an effective data confirmation step S300-1 for confirming whether effective parking/stopping data is stored in the vehicle data storage unit, an effective data transmission step S300-2 for transmitting the effective parking/stopping data to the main system through the data transmit and receive unit if the effective parking/stopping data is stored in the vehicle data storage unit, an acknowledgement receiving step S300-3 for receiving an acknowledgement confirming that the main system has received the effective parking/stopping data, from the main system through the data transmit and receive unit, and a data deletion step S300-4 for deleting the effective parking/stopping data transmitted to the main system from the vehicle data storage unit if the acknowledgement is received.

In the effective data confirmation step S300-1, it is confirmed whether effective parking/stopping data is stored in the vehicle data storage unit. The effective data is parking/stopping data of the vehicle that is not yet transmitted to the main system.

In the effective data transmission step S300-2, if the effective parking/stopping data is stored in the vehicle data storage unit, the effective parking/stopping data is transmitted to the main system.

In the acknowledgement receiving step S300-3, if the main system receives the effective parking/stopping data, the main system transmits an acknowledgement indicating that the main system receives the effective parking/stopping data from the equipment unit, and the equipment unit receives the acknowledgement.

In the data deletion step S300-4, which is needed for efficient use of storage space, the transmitted effective parking/stopping data is deleted from the vehicle data storage unit. Otherwise, the vehicle data storage unit is full of data and may not continue to store parking/stopping data.

In addition, the present invention further preferably includes a data output step S550 for outputting the parking/stopping data stored in the system data storage unit through the output unit.

The data output step S550 is performed by the output unit described above. In the data output step, the parking/stopping data is outputted to be recognized by a user through a monitor, printer, or the like, and thus a hit-and-run vehicle may be conveniently inquired.

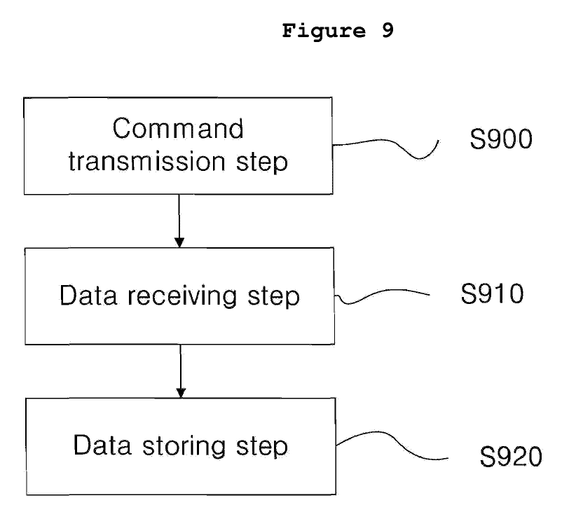

FIG. 9 is a flowchart illustrating a method of an embodiment of the present invention configured such that the main system receives signals through a command. The method includes a command transmission step S900, a data receiving step S910, and a data storing step S920.

In the command transmission step S900, the main system transmits a command to the equipment unit of a vehicle through the system transmit and receive unit. The command directs the equipment unit to transmit parking/stopping data of the vehicle. The command may contain data for identifying a command type, transmission interval, valid time of the command (start date or time), data for limiting the command to a specific area and to some vehicles, and the like.

In the data receiving step S910, the equipment unit of the vehicle receives the command and transmits parking/stopping data created by the equipment unit mounted on the vehicle, and the system management unit receives the parking/stopping data of the vehicle through the system transmit and receive unit.

The data receiving step S910 is not different from the previously described data receiving step. The determination control unit of the equipment unit executes the command based on previously defined steps of the command and transmits the parking/stopping data of the vehicle. Through the steps described above, the main system may receive parking/stopping data in real-time from a vehicle in a desired area and view the parking/stopping data. Therefore, through the received parking/stopping data, vehicles illegally parked/stopped in a specific area may be checked, and traffic conditions of the area may be understood in real-time. Furthermore, the state of a specific vehicle may be advantageously captured in real-time.

In the data storing step S920, the received parking/stopping data is stored in the system storage unit, which is the same as the previously described data storing step.

Although the present invention has been described with reference to embodiments, the description is illustrative of the invention and is not to be construed as limiting the invention. Various modifications and variations may occur to those skilled in the art, without departing from the scope of the invention as defined by the appended claims.

What is claimed is:

1. A vehicle record management system for managing parking/stopping records of a vehicle to capture location information of the vehicle, the system comprising:
an equipment unit mounted on the vehicle, for creating and transmitting parking/stopping data of the vehicle; and
a main system for receiving the parking/stopping data of the vehicle from the equipment unit and classifying, accumulating, and managing the received parking/stopping data, wherein the equipment unit includes:
an information collection unit for collecting vehicle information including the location information of the vehicle;
a determination control unit for determining whether the vehicle is parked/stopped based on the collected vehicle information and creating the parking/stopping data; and
a data transmit and receive unit for transmitting the parking/stopping data created by the determination control unit or receiving data from the main system, and
the main system includes:
a system transmit and receive unit for receiving the parking/stopping data of the vehicle transmitted from the equipment unit or transmitting data to the equipment unit; and
a system management unit for managing the parking/stopping data of the vehicle and outputting the parking/stopping data in a recognizable form.

2. A vehicle record management system for managing parking/stopping records of vehicles to capture location information of the vehicles, the system comprising:
a first equipment unit attached to a first vehicle, for creating and transmitting parking/stopping data of the first vehicle;
a second equipment unit attached to at least one second vehicle other than the first vehicle, for creating and transmitting parking/stopping data of the second vehicle; and
a main system for receiving the parking/stopping data of the first and second vehicles from the first and second equipment units and classifying, accumulating, and managing the received parking/stopping data, wherein
the first and second equipment units of the first and second vehicles respectively include:
an information collection unit for collecting vehicle information including the location information of the vehicle;
a determination control unit for determining whether the vehicle is parked/stopped based on the collected vehicle information and creating the parking/stopping data; and
a data transmit and receive unit for transmitting the parking/stopping data created by the determination control unit or receiving data from the main system, wherein the first and second equipment units of the first and second vehicles are capable of transmitting the parking/stopping data to the main system by transmitting and receiving the parking/stopping data with each other and, and
the main system includes:
a system transmit and receive unit for receiving the parking/stopping data of the vehicles transmitted from the first and second equipment units of the first and second vehicles or transmitting data to the equipment units; and
a system management unit for managing the parking/stopping data of the vehicles and outputting the parking/stopping data in a recognizable form.

3. An equipment unit used in a vehicle record management system, the equipment unit comprising:
an information collection unit for collecting vehicle information including location information of the vehicle;
a determination control unit for determining whether the vehicle is parked/stopped based on the collected vehicle information and creating parking/stopping data; and
a data transmit and receive unit for transmitting the parking/stopping data created by the determination control unit or receiving data.

4. A main system used in a vehicle record management system, for receiving parking/stopping data of a vehicle from the equipment unit of claim 3 and classifying, accumulating, and managing the received parking/stopping data, the main system comprising:
a system transmit and receive unit for receiving the parking/stopping data of the vehicle transmitted from the equipment unit or transmitting data to the equipment unit; and
a system management unit for managing the parking/stopping data of the vehicle and outputting the parking/stopping data in a recognizable form.

5. The vehicle record management system according to claim 1, wherein the equipment unit further comprises a vehicle data storage unit for storing the parking/stopping data created by the determination control unit.

6. The vehicle record management system according to claim 1, wherein the main system further comprises a system data storage unit for storing the parking/stopping data received through the system transmit and receive unit.

7. The vehicle record management system according to claim 1, wherein the information collection unit includes a location information receiver for receiving signals related to the location information of the vehicle from a satellite, and a vehicle information recording unit for recoding the vehicle information.

8. The vehicle record management system according to claim 1, wherein the vehicle information includes the location information, speed information, brake signals, and registration information of the vehicle.

9. The vehicle record management system according to claim 1, wherein the data transmit and receive unit of the equipment unit transmits and receives data to and from the system transmit and receive unit of the main system through a wire/wireless communication network.

10. The vehicle record management system according to claim 1, wherein the parking/stopping data of the vehicle is log data recoding locations and times of parking/stopping of the vehicle.

11. The vehicle record management system according to claim 1, wherein the equipment unit is formed together with a license plate of the vehicle as a single body.

12. A method of managing records of a vehicle performed by the system of claim 1, the method comprising:
an information collection step for receiving vehicle information including location information of the vehicle collected by an information collection unit, by a determination control unit;
a determination and data creation step for analyzing the received vehicle information, determining whether the vehicle is parked/stopped, and creating parking/stopping data; and
a data transmission step for transmitting the created parking/stopping data to a main system through a data transmit and receive unit.

13. A method of managing records of a vehicle performed by the main system of claim 6, the method comprising:
a data receiving step for receiving parking/stopping data created and transmitted by an equipment unit attached to the vehicle through a system transmit and receive unit, by a system management unit; and
a system data storing step for storing the received parking/stopping data into a system data storage unit.

14. A method of managing records of a vehicle performed by the main system of claim 6, the method comprising:
an information collection step for receiving vehicle information including location information of the vehicle collected by an information collection unit, by a determination control unit;
a determination and data creation step for analyzing the received vehicle information, determining whether the vehicle is parked/stopped, and creating parking/stopping data, by a determination control unit;
a data transmission step for transmitting the created parking/stopping data to the main system through a data transmit and receive unit;
a data receiving step for receiving the created and transmitted parking/stopping data through a system transmit and receive unit, by a system management unit; and
a system data storing step for storing the received parking/stopping data into a system data storage unit.

15. A method of managing records of a vehicle performed by the equipment unit of claim 3, the method comprising:
an information collection step for receiving vehicle information including location information of the vehicle collected by an information collection unit, by a determination control unit;
a determination and data creation step for analyzing the received vehicle information, determining whether the vehicle is parked/stopped, and creating parking/stopping data; and
a data transmission step for transmitting the created parking/stopping data to an equipment unit of another vehicle through a data transmit and receive unit.

16. The method according to claim 12, further comprising a vehicle data storing step for storing the parking/stopping data of the vehicle into a vehicle data storage unit.

17. The method according to claim 13, further comprising a data output step for outputting the parking/stopping data stored in the system data storage unit through an output unit.

18. The method according to claim 16, wherein the transmission step includes:
an effective data confirmation step for confirming whether effective parking/stopping data is stored in the vehicle data storage unit;
an effective data transmission step for transmitting the effective parking/stopping data to a main system through the data transmit and receive unit if the effective parking/stopping data is stored in the vehicle data storage unit;
an acknowledgement receiving step for receiving an acknowledgement confirming that the main system has received the effective parking/stopping data from the main system through the data transmit and receive unit; and
a data deletion step for deleting the effective parking/stopping data transmitted to the main system from the vehicle data storage unit if the acknowledgement is received.

19. The method according to claim 12, wherein the determination and data creation step includes:
an engine-start confirmation step for receiving the vehicle information from a vehicle information recording unit and confirming whether an engine of the vehicle is started, by the determination control unit;
a parking/stopping confirmation step for confirming whether the vehicle is in a parking/stopping state if the engine of the vehicle is started; and
a data creation step for creating the parking/stopping data of the vehicle including the location information and the vehicle information of the vehicle if the vehicle in a parking/stopping state.

20. A method of managing records of a vehicle performed by the main system of claim 6, the method comprising:
a command transmission step for transmitting a command to an equipment unit of the vehicle through a system transmit and receive unit, the command directing the equipment unit to transmit parking/stopping data of the vehicle;
a data receiving step for receiving the parking/stopping data of the vehicle created and transmitted by the equipment unit mounted on the vehicle in response to the command received by the equipment unit of the vehicle, by a system management unit; and
a data storing step for storing the received parking/stopping data in a system storage unit.
